(19) United States
(12) Patent Application Publication
(10) Pub. No.: US 2005/0094931 A1
(43) Pub. Date: May 5, 2005

(54) Optical switch and production method therefor, information transmission device using it

(76) Inventors: Kazuo Yokoyama, Osaka (JP); Katsuhiko Asai, Nara (JP); Yousuke Irie, Nara (JP); Shinichiro Aoki, Kanagawa (JP); Kouji Nomura, Shijonawate, Osaka (JP); Katsuya Morinaka, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/501,893

(22) PCT Filed: Jan. 20, 2003
(86) PCT No.: PCT/JP03/00401

(30) Foreign Application Priority Data
Jan. 21, 2002 (JP) 2002-011342
Apr. 22, 2002 (JP) 2002-118900

(51) Int. Cl. G02B 6/26

(52) U.S. Cl. 385/18

(57) ABSTRACT

On a substrate are configured piezoelectric elements composed of a mirror device, piezoelectric thin films, electrodes, and elastic members, and application of a voltage to the electrodes causes flexure deformation in the piezoelectric thin films, so that the mirror device is actuated. A plurality of the piezoelectric elements are arranged in parallel with a longitudinal direction thereof, and torsion springs are provided so as to extend in a direction orthogonal to the longitudinal direction and so as to hold the mirror device in connection with the substrate. The mirror device is connected to the piezoelectric elements through strain absorbers. In such a configuration, the torsion springs serve as a rotation axis, and the mirror device is inclined about the rotation axis.

### TECHNICAL FIELD

The present invention relates to an optical switch, a method of manufacturing the same, and an information transmission device using the same, and particularly relates to an optical switch having actuators for actuating mirror devices and an information transmission device using the switch.

### BACKGROUND ART

In recent years, information transmission devices using light have become fundamental devices for achieving shift toward broadband in the Internet and for achieving high-speed high-capacity information communication, with development of transmission-speeding-up technologies such as wavelength segmenting multiplex.

For efficient connection in optical communication networks, various optical switches having a function as an exchange at light signal level, a function as an optical attenuator, and the like have become indispensable devices.

Optical communication networks have been developed mainly and especially in basic trunk systems, and optical switches will increasingly be required also at terminals nearer to homes, in units of local cities or local residential quarters.

For further prevalence of optical switches in optical communication networks, optical switches are demanded that satisfy basic performance such as insertion loss on the order of about −60 dB and switching time and that can be manufactured with simpler configuration and at lower cost than before.

As a conventional example of optical switch, an optical switch for switching an optical fiber for input signal to an optical fiber for output signal by electromagnetic actuation is disclosed in “MOEMS 97, Technical Digest (1997, p165-p170).” The optical switch of this type has defects in that necessity for actuation of a comparatively large mass of the optical fiber itself puts a limit on reduction in the switching time and results in necessity for a large current for the electromagnetic actuation.

As another conventional example of optical switch, an optical switch that switches optical paths by moving oil with which a part of a waveguide has been filled or by heating the oil and making bubbles is disclosed in “MOEMS 97, Technical Digest (1997, p238-p242).” The optical switch of this type has a defect in that a relatively large insertion loss is involved by control of reflectance of a reflection interface according to presence or absence of oil on the reflection interface.

In “MOEMS 97, Technical Digest (1997, p233-p237)” is disclosed an optical switch that switches optical paths by mirrors of electrostatic actuation type. The optical switch of this type has defects in that high voltage is required in general for electrostatic actuation and in that necessity for electrostatic gap on the order of microns for obtaining a large actuating force involves sophisticated microfabrication for manufacturing the switch.

An optical switch associated with the present invention that is piezoelectrically actuated by a piezoelectric thin film is not disclosed in documents on the prior arts of optical switch that have already been published.

In order to achieve further prevalence of optical switches, as described above, it is an important subject to provide optical switches that satisfy basic performance on insertion loss, switching time, and the like, that allow electric power for actuation to be decreased, and that can be manufactured with simple configuration and at low cost. Besides, it is necessary to switch a large number of optical transmission lines in a compact configuration.

In a device disclosed in Japanese unexamined patent publication No. 2000-339725, as shown in FIG. 10, a regularly polygonal micromirror 122 is arranged at a center of a silicon plate on a substrate 121, a cantilever 123 is arranged along each side of the mirror 122, one end of the cantilever 123 is fixed and the other end thereof is attached to one end of the side of the mirror 122, while a piezoelectric member is formed on a surface or in inside of the cantilever 123 along a longitudinal direction of the cantilever 123, the same voltage is applied to all the piezoelectric members, and the mirror 122 is translationally moved with utilization of bend of a tip end of the cantilever 123. Reference numeral 124 denotes piezoelectric member.

In a device disclosed in Japanese unexamined patent publication No. 2001-033713, as shown in FIG. 11, light having outgone from a light source is reflected by a mirror 106 that is on a substrate 101, that is inclined at 45 degrees relative to the light, and that is translationally moved in directions inclined at 45 degrees, the mirror 106 is placed on a square supporting body 104, a cantilever 103 is arranged on each side of the supporting body 104 so that a tip end of the cantilever supports the supporting body 104, piezoelectric member 105 is arranged on a surface of the cantilever 103, along a longitudinal direction of the cantilever 123, the piezoelectric member 105 is displaced by application to a voltage to the piezoelectric member 105, and the mirror 106 is translationally moved with resultant displacement of the cantilevers 103.

For both of the above two publications, however, a flexure force is developed in each of the four cantilevers 103, 123 surrounding the mirror 105, 122, and difficulty in the translational movement of the mirror 105, 122 with balance of the four flexure forces is prone to result in unstable control of the translational movement. There is a possibility that unbalance of the four flexure forces may immediately cause a turning force because the four cantilevers 103, 123 are arranged symmetrically with respect to a point. The light has to be made incident on an area within several microns of the center of the mirror 106, 122 in order that such situation may be prevented as much as possible, and there is an issue in that the area substantially usable on the mirror 106, 122 is minute.

In view of the above-mentioned issues, an object of the present invention is to provide an optical switch which enables high-speed high-accuracy light switching and low-voltage low-power actuation corresponding to expansion of optical communication networks with increase in speed and capacity, which is compact as a device, which has a specific configuration at practical level including easiness of manufacture, which allows stable switching control, and in which a substantially usable area is large; a method of manufacturing the same; and an information transmission device using the same.

### DISCLOSURE OF INVENTION

In order to achieve the above object, the present invention is configured as follows.

According to a first aspect of the present invention, there is provided an optical switch comprising a mirror device for reflecting light from an optical transmission path on incident side and actuators for actuating the mirror device,
the mirror device adapted for switching an optical path of the light incident from the optical transmission path on incident side into an optical transmission path on outgoing side by the actuation performed by the actuator,
the actuators configured by piezoelectric elements comprising piezoelectric thin films, electrodes for applying voltage for actuating the piezoelectric thin films, and elastic members having the piezoelectric thin films and the electrodes, the optical switch, wherein longitudinal directions of the piezoelectric elements confronting across the mirror device are parallel and wherein the mirror device is actuated by flexure deformation of the piezoelectric thin films which is caused by application of voltage to the electrodes.

According to a second aspect of the present invention, there is provided an optical switch as defined in the first aspect, wherein a mirror surface is provided on the mirror device in a plane that is parallel to the piezoelectric thin films and wherein the mirror device is inclined by the actuators relative to the plane that is parallel to the piezoelectric thin films.

According to a third aspect of the present invention, there is provided an optical switch as defined in the second aspect, wherein the actuators comprise a plurality of piezoelectric elements of which the longitudinal directions are arranged in parallel, wherein the mirror device is held by torsion springs that are arranged so as to be orthogonal to the longitudinal directions, and wherein the mirror is thus inclined in a rotation direction such that the torsion springs serve as a rotation axis.

According to a fourth aspect of the present invention, there is provided an optical switch as defined in the second aspect, wherein the actuators comprise at least a plurality of piezoelectric elements of which both ends are supported as fixed ends and of which the longitudinal directions are arranged in parallel and wherein strain absorbers extending along the longitudinal directions are provided in part of the piezoelectric elements with respect to the longitudinal directions (so as to enhance the deformation efficiency of the flexure deformation).

According to a fifth aspect of the present invention, there is provided an optical switch as defined in the first aspect, wherein the actuators are composed of a plurality of piezoelectric elements, wherein each of the piezoelectric elements is partitioned into a plurality of electrodes, and wherein application of different voltages to the electrodes causes the piezoelectric thin films to undergo flexure deformation with different curvatures.

According to a sixth aspect of the present invention, there is provided an optical switch as defined in the first aspect, wherein the elastic members constituting the piezoelectric elements at least include silicon thin films or silicon oxide films that have constituted a Silicon-on-Insulator substrate.

According to a seventh aspect of the present invention, there is provided an optical switch as defined in the first aspect, wherein mirror surfaces are provided on the mirror device so as to extend in a direction of a normal to the piezoelectric thin films and wherein the actuators actuate the mirror device in the direction of the normal to the piezoelectric thin films.

According to an eighth aspect of the present invention, there is provided an optical switch as defined in the seventh aspect, wherein the actuators comprise at least a plurality of piezoelectric elements of which both ends are supported as fixed ends and of which the longitudinal directions are arranged in parallel and wherein strain absorbers extending along the longitudinal directions are configured in part of the piezoelectric elements with respect to the longitudinal directions (so as to enhance the deformation efficiency of the flexure deformation).

According to a ninth aspect of the present invention, there is provided an optical switch as defined in the second or seventh aspect, wherein the actuators comprise at least a plurality of piezoelectric elements of which both ends are supported as fixed ends and of which the longitudinal directions are arranged in parallel and wherein low-flexural-rigidity parts that flex with a reverse curvature with respect to a flexure curvature of the piezoelectric elements are configured (so as to enhance the deformation efficiency of the flexure deformation).

According to a 10th aspect of the present invention, there is provided an optical switch as defined in the second or seventh aspect, wherein the actuators comprise a mirror device holding device for holding the mirror device in a specified position after translational movement of the mirror device.

According to an 11th aspect of the present invention, there is provided an optical switch as defined in the second or seventh aspect, wherein the mirror device holding device is a device that holds the mirror device by electrostatic actuation independent of the actuation of the piezoelectric thin films or mechanically and wherein the application of the voltage to the piezoelectric thin films is canceled when the mirror device is held.

According to a 12th aspect of the present invention, there is provided a method of manufacturing an optical switch comprising a mirror device for reflecting light from an optical transmission path on incident side and actuators for actuating the mirror device, the mirror device adapted for switching an optical path of the light incident from the optical transmission path on incident side into an optical transmission path on outgoing side by the actuation performed by the actuator,
the method comprising manufacturing a piezoelectric element of the actuators by transferring a piezoelectric thin film formed on a substrate onto another substrate.

According to a 13th aspect of the present invention, there is provided a method of manufacturing an optical switch comprising a mirror device for reflecting light from an optical transmission path on incident side and actuators for actuating the mirror device, the mirror device adapted for switching an optical path of the light incident from the optical transmission path on incident side into an optical transmission path on outgoing side by the actuation performed by the actuators,
the method comprising manufacturing a piezoelectric element of the actuators by directly producing a piezoelectric thin film on a substrate.

According to a 14th aspect of the present invention, there is provided a method of manufacturing an optical switch as defined in the 13th aspect, wherein the substrate on which the piezoelectric thin film is produced is a Silicon-on-Insulator substrate.

According to a 15th aspect of the present invention, there is provided an information transmission device using an optical switch comprising a mirror device for reflecting light from an optical transmission path on incident side and actuators for actuating the mirror device, the mirror device adapted for switching an optical path of the light incident from the optical transmission path on incident side into an optical transmission path on outgoing side by the actuation performed by the actuator,
the actuators configured by piezoelectric elements comprising piezoelectric thin films, electrodes for applying voltage for actuating the piezoelectric thin films, and elastic members having the piezoelectric thin films and the electrodes, wherein longitudinal directions of the piezoelectric elements confronting across the mirror device are parallel, and wherein the mirror device is actuated by flexure deformation of the piezoelectric thin films which is caused by application of voltage to the electrodes.

According to a 16th aspect of the present invention, there is provided an information transmission device as defined in the 15th aspect, wherein a mirror surface is provided on the mirror device in a plane that is parallel to the piezoelectric thin films, wherein the mirror device is inclined by the actuators relative to the plane parallel to the piezoelectric thin films, and wherein a plurality of the optical transmission paths arranged in a plane generally normal to the thin films are thus switched by control of an angle of reflection of the mirror surface.

According to a 17th aspect of the present invention, there is provided an information transmission device as defined in the 15th aspect, wherein mirror surfaces are provided on the mirror device so as to extend in a direction of a normal to the piezoelectric thin films and wherein by actuating by the actuators the mirror device in the direction of the normal to the piezoelectric thin films, the mirror device is inserted into a plurality of the optical transmission paths arranged in a plane in parallel with the thin films, and switch the transmission paths.

According to an 18th aspect of the present invention, there is provided an information transmission device as defined in the 16th or 17th aspect, wherein the actuators comprise a plurality of rows of piezoelectric elements having longitudinal directions arranged in parallel and wherein the plurality of optical transmission paths are arranged in correspondence to the plurality of rows of piezoelectric elements.

### BRIEF DESCRIPTION OF DRAWINGS

These and other aspects and features of the present invention will become clear from the following description taken in conjunction with the preferred embodiments thereof with reference to the accompanying drawings, in which:

FIG. 1A is a perspective view of an optical switch of a first embodiment of the present invention (electrode parts are shown with hatching, for easy understanding);

FIG. 1B is a perspective view of an optical switch of a modification of the first embodiment of the present invention (electrode parts are shown with hatching, for easy understanding);

FIGS. 1C, 1D, and 1E are enlarged plan views of strain absorbers of optical switches in various modifications of the first embodiment of the present invention (the strain absorbers are shown with hatching, for easy understanding);

FIG. 2A is a sectional view representing a part of the optical switch of the first embodiment of the present invention;

FIGS. 2B and 2C are graphs showing a relation between voltage between electrodes 4a and 4c and time and a relation between voltage between electrodes 4b and 4c and time, respectively, in the optical switch of the first embodiment of the present invention;

FIG. 3 is a sectional view for illustrating a principle of switching of optical transmission paths in the optical switch of the first embodiment of the present invention;

FIGS. 4A and 4B are graphs that represent a frequency response characteristic showing a relation between mirror end displacement and frequency in the first embodiment of the present invention;

FIG. 5A is a perspective view of an optical switch of a second embodiment of the present invention (electrode parts are shown with hatching, for easy understanding);

FIG. 5B is a perspective view of an optical switch of a modification of the second embodiment of the present invention (electrode parts are shown with hatching, for easy understanding);

FIGS. 5C, 5D, 5E, and 5F are enlarged plan views of low-flexural-rigidity parts of optical switches in various modifications of the second embodiment of the present invention (the low-flexural-rigidity parts are shown with hatching, for easy understanding);

FIGS. 6A and 6B are a plan view and a side view in which the optical switch of the second embodiment of the present invention is shown with transmission lines (the electrode parts are shown with hatching, for easy understanding);

FIGS. 7A and 7B are a plan view and a side view of an information transmission device of a third embodiment of the present invention;

FIGS. 8A, 8B, and 8C are process views for illustrating a method of manufacturing the optical switch of the first embodiment;

FIGS. 9A, 9B, and 9C are process views for illustrating manufacturing processes using a Silicon-on-Insulator (SOI) substrate in the method of manufacturing the optical switch of the first embodiment;

FIG. 10 is a perspective view showing a structure of a conventional micromirror device; and

FIG. 11 is a perspective view showing a structure of a conventional micromirror device.

### BEST MODE FOR CARRYING OUT THE INVENTION

Before the description of the present invention proceeds, it is to be noted that like parts are designated by like reference numerals throughout the accompanying drawings.

(First Embodiment)

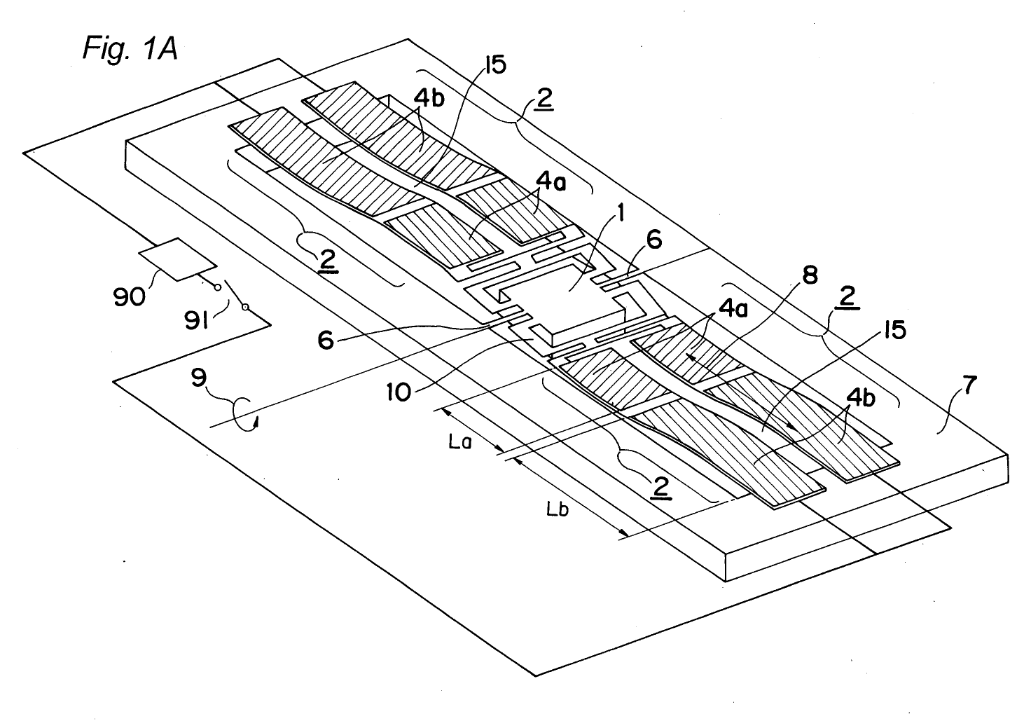

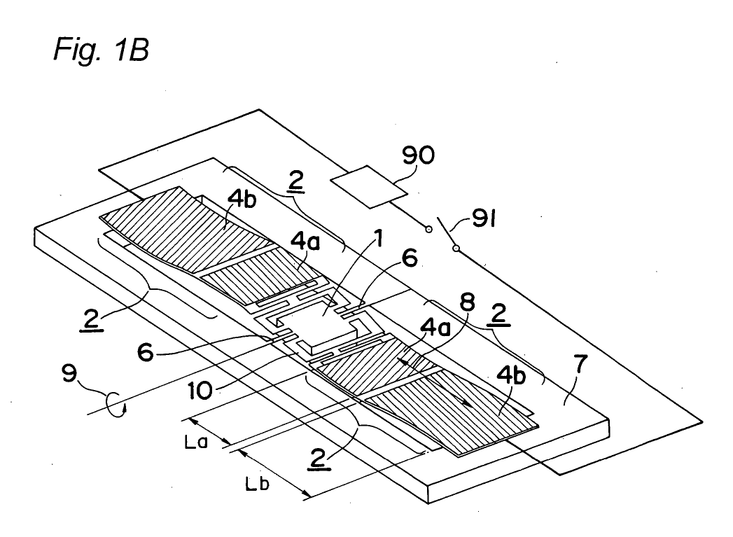

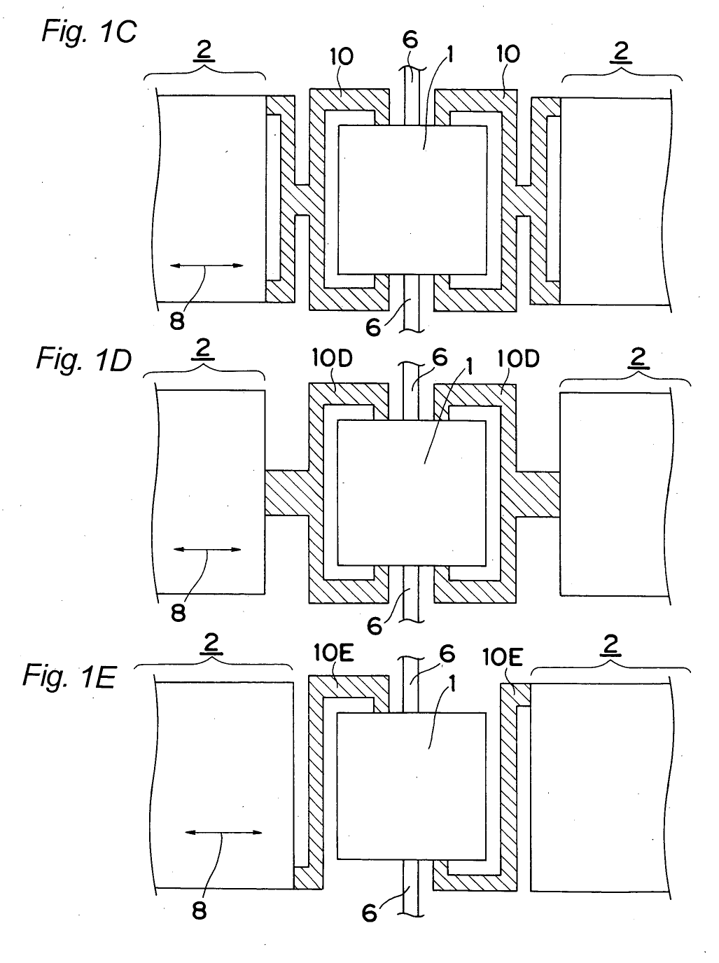

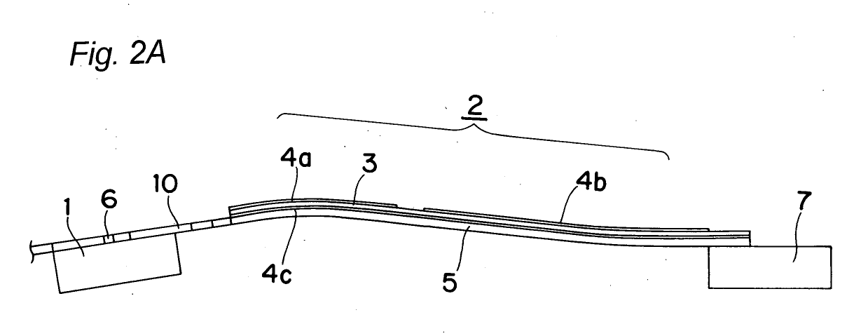

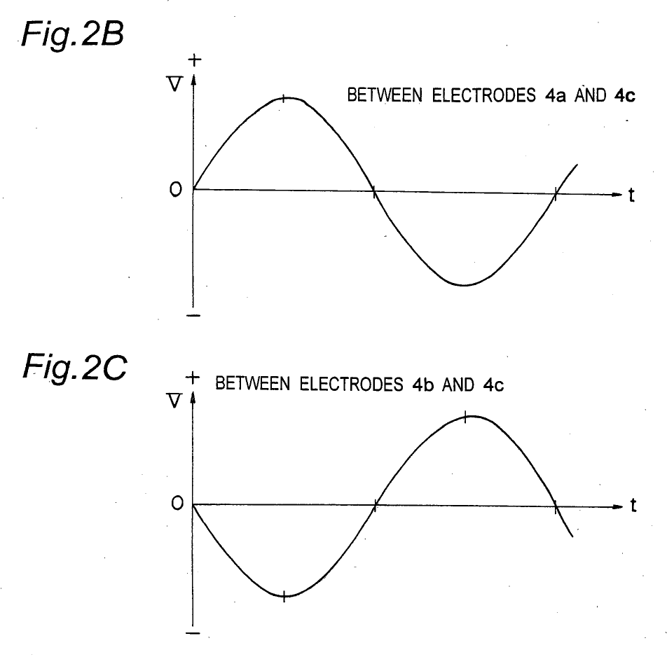

FIG. 1A shows a perspective view of an optical switch of a first embodiment of the present invention, and FIG. 1B shows a perspective view of an optical switch of a modification of the first embodiment of the present invention. FIG. 2A shows a sectional view representing a part of the optical switch of the first embodiment of the present invention.

On a substrate 7, piezoelectric elements 2 are configured, on both sides of a mirror device 1 symmetrically with respect to a line, by the mirror device 1, piezoelectric thin films (thin film-shaped piezoelectric members) 3 placed on both sides of the mirror device 1 axis-symmetrically with respect to a rotation axis 9, first upper electrodes 4a placed on the mirror device side on upper surfaces of the piezoelectric thin films 3, second upper electrodes 4b placed opposite to the mirror device side on the upper surfaces of the piezoelectric thin films 3 at a distance from the first upper electrodes 4a, lower electrodes 4c placed on lower surfaces of the piezoelectric thin films 3, and elastic members 5 placed on lower surfaces of the lower electrodes 4c and on the substrate 7. Upon closure of a switch 91 in a circuit, a voltage from a power supply 90 is applied to the first and second upper electrodes 4a, 4b and to the lower electrodes 4c, and the piezoelectric thin films 3 thereby undergo flexure deformation, so that the mirror device 1 is turned about the rotation axis 9. A pair of the piezoelectric elements 2 are arranged, with a clearance between, in parallel with a longitudinal direction 8 of the substrate 7, that is, of the piezoelectric elements 2 in FIG. 1A, torsion springs 6 are provided so as to extend in a direction orthogonal to the longitudinal direction 8, and the torsion springs 6 hold the mirror device 1 in connection with the substrate 7. The mirror device 1 is connected to the piezoelectric elements 2 through strain absorbers 10.

The first upper electrode 4a formed on the piezoelectric film 3 is preferably placed in a position in front of or in vicinity of a point of inflection of the piezoelectric film 3, as seen from the side of the second upper electrode 4b toward the mirror device 1. That is because placement of the electrode beyond the point of inflection might cause adverse effects such as unstable flexure actuation. In the two prior publications, particularly, the placement of the electrode beyond the point of inflection is prone to cause unstable flexure actuation and makes it difficult to perform accurate actuation control.

The two upper electrodes 4a and 4b and the lower electrode 4c are formed on the piezoelectric thin film 3, and the piezoelectric thin film 3 is polarized with respect to a direction of thickness of the film. The reason for that is as follows. If the upper electrodes are configured as one electrode on the piezoelectric thin film 3 as in the two prior publications, it is made impossible to control a position of the point of inflection where a direction of the flexure is inverted between a part on the mirror device side and a part opposite to the mirror device, and the flexure actuation is thereby made unstable. By partition into the first upper electrode 4a and the second upper electrode 4b and by application of different voltages to the electrodes 4a and 4b with the electrode 4c at a midpoint potential, in contrast to that, flexure deformation with reversal of curvature in the electrode 4a and the electrode 4b can be caused, the position of the point of inflection thus can accurately be controlled, and the flexure actuation can be stabilized. As a result, stabilization of a direction of inclination enables high-speed high-accuracy light switching and leads to satisfactory response.

A flatness of the mirror device 1 is preferably in a range of from (1/100)λ to (1/1000)λ (wherein λ is a wavelength of the light incident on the mirror device 1).

Such a configuration forms an actuator which has the torsion springs 6 as the rotation axis 9 and in which the mirror device 1 is actuated by the piezoelectric elements 2 so as to be inclined about the rotation axis 9. Fixation of the rotation axis 9 of the mirror device 1 by the torsion springs 6 makes it possible to actuate the mirror device 1 with high accuracy and stably toward disturbance.

With reference to the sectional view of FIG. 2A, a principle of the actuation by the piezoelectric elements 2 will be described.

The two upper electrodes 4a and 4b and the lower electrode 4c are formed on the piezoelectric thin film 3, and the piezoelectric thin film 3 is polarized with respect to the direction of thickness of the film.

Application of voltages between the electrodes confronting across the piezoelectric thin film 3 (between the electrode 4a and the electrode 4c and between the electrode 4b and the electrode 4c) causes strain according to a piezoelectric constant d₃₁ in a surface of the piezoelectric thin film 3, while the application of the voltages causes no strain in the elastic member 5. As a result, flexure deformation is caused in the piezoelectric element 2 composed of the piezoelectric film 3, the electrodes 4a, 4b, 4c, and the elastic member 5.

The application of different voltages to the electrodes 4a and 4b with the electrode 4c at the midpoint potential causes flexure deformation with reversal of curvature in the electrode 4a and the electrode 4b. As a result, the mirror device 1 can efficiently be inclined about the rotation axis 9 that is the torsion springs 6 holding the mirror device 1.

FIGS. 2B and 2C are diagrams for illustrating a method of applying voltages having opposite phases to the electrodes 4a and 4b. FIG. 2B shows a voltage waveform of alternating voltage applied between the upper electrode 4a and the lower electrode 4c. FIG. 2C shows a voltage waveform of alternating voltage that has the opposite phase and that is applied between the upper electrode 4b and the lower electrode 4c. As a consequence, flexure deformation is caused with reversal of curvature in the upper electrode 4a and the upper electrode 4b, and the mirror device 1 can efficiently be inclined.

A distance between a fixed end of the piezoelectric element 2 and the torsion springs 6 is structurally fixed, and therefore strain or displacement of the piezoelectric element 2 in the longitudinal direction with such flexure deformation of the piezoelectric element 2 tends to be restrained, so that the mirror device 1 is hindered from being efficiently inclined. As means for relieving this restraint, the strain absorber 10 having a structure with rigidity reduced from that of the piezoelectric element 2 in the longitudinal direction is provided between the piezoelectric element 2 and the mirror device 1. The mirror device 1 can efficiently be inclined with assistance of this configuration with effects of the configuration of the multi-partitioned electrodes.

In the first embodiment of FIG. 1A, curvature resulting from strain in the piezoelectric element 2 is formed not only in the longitudinal direction 8 thereof but also in a direction of width thereof, and the piezoelectric element 2 is configured so as to be partitioned into two parts in parallel with the longitudinal direction 8 in order that the curvature in the direction of the width may be prevented from interfering with the flexure deformation in the longitudinal direction. On condition that a length of the piezoelectric element 2 in the longitudinal direction 8 is sufficiently larger than a size of the same in the direction of the width, the piezoelectric element 2 is not necessarily required to be partitioned into two parts, as shown in FIG. 1B.

That is, the piezoelectric element 2 may be arranged as one body along the longitudinal direction 8 thereof, as shown in FIG. 1B. FIG. 1B shows a simple configuration in which grooves 15 are not provided and in which the piezoelectric elements 2 are not partitioned in the structure shown in FIG. 1A. In the optical switch of FIG. 1B, in comparison with the configuration of FIG. 1A, generated displacement is decreased by influence of the flexure in the direction of the width orthogonal to the longitudinal direction 8 of the piezoelectric element 2, while the rigidity of the piezoelectric element 2 is increased. Consequently, there can be obtained a structure with a high resonance frequency and the switch excellent in rapid response. FIGS. 1C through 1E are partially plan views showing various modifications different in shape of the strain absorbers 10. FIG. 1C shows a configuration with the same shape as the strain absorber 10 shown in FIG. 1A has, that is, the strain absorber 10 in which both sides of an alphabetic character “H” are bent generally in shape of a character “C” and in shape of the reverse of the character “C.” By contrast, FIG. 1D shows strain absorbers 10D having a configuration in which only a center part of the strain absorber 10 is connected to the piezoelectric element 2. In the configuration of FIG. 1D, the rigidity of the strain absorbers 10D in the longitudinal direction 8 is larger than that in FIG. 1C, and therefore an actuation angle of the mirror device 1 is made small; however, there can be obtained a structure that has a high resonance frequency and that is excellent in rapid response. FIG. 1E shows another example of configuration of the strain absorber 10 in which a strain absorber 10E is connected to ends on different sides of the mirror device 1 and the piezoelectric element 2. For example, in FIG. 1E, a lower end of the left piezoelectric element 2 and an upper end of the mirror device 1 are connected via a double-end-hook-like member, and a lower end of the mirror device 1 and an upper end of the right piezoelectric element 2 are connected via a double-end-hook-like member. In such a structure, a thin beam section of the strain absorber 10E can be made to extend in a long length in the direction orthogonal to the longitudinal direction 8 of the piezoelectric element 2, thus the rigidity in the longitudinal direction 8 can be decreased with use of a comparatively small space, and the actuation angle of the mirror device 1 can be increased.

Though structures of interconnections (wiring) to the electrodes 4a, 4b, and 4c are not shown in the drawings, an interconnection to the first upper electrode 4a near to the movable part in the two partitioned upper electrodes (that is, near to the mirror device 1) may have a structure such that the interconnection is drawn out to surroundings of the substrate 7 through the strain absorber 10, 10D, 10E and the torsion spring 6.

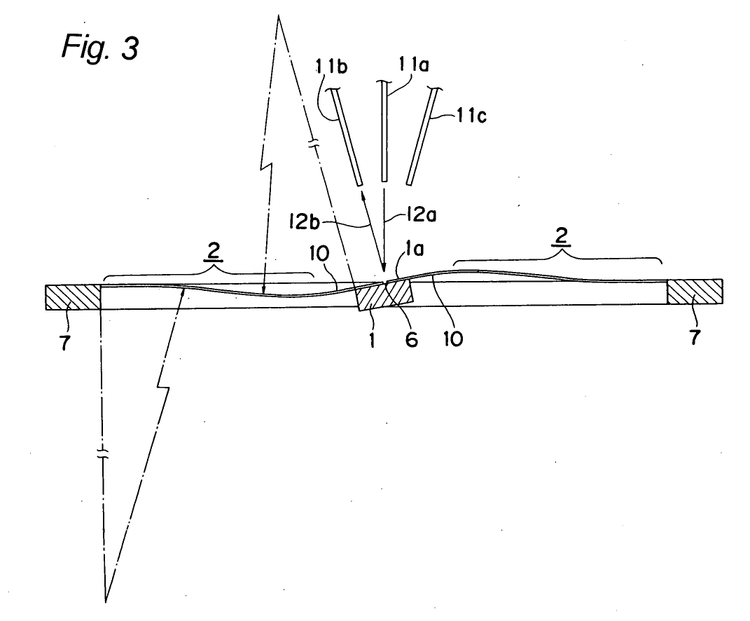

FIG. 3 shows a sectional view for illustrating a principle of switching of optical transmission paths in the optical switch of the first embodiment of the present invention. A light beam 12a having outgone from an optical transmission path 11a is incident on a mirror surface 1a of the mirror device 1 and is reflected by the mirror surface 1a. When the mirror surface 1a turned and inclined by actuation of the piezoelectric elements 2 is in an inclined position as shown in FIG. 3, the light beam 12a is reflected from the mirror surface 1a in a direction of an arrow 12b and is made incident on an optical transmission path 11b. When the mirror surface is in a position turned and inclined in the opposite direction, the light beam is made incident on an optical transmission path 11c. In this manner, a turning angle of the mirror device 1 is controlled by actuation of the piezoelectric elements 2, and thus input light can be outputted to different optical transmission paths. On condition that the optical transmission paths are optical fibers of index gradient type, the incident light beam has been collimated to a certain degree and is then made incident on an optical fiber for output. Provided that a range of the achieving beam is required to be lengthened in terms of a configuration of the optical switch, collimator lenses (not shown) are provided at emission ends and/or reception ends of the optical fibers as necessary.

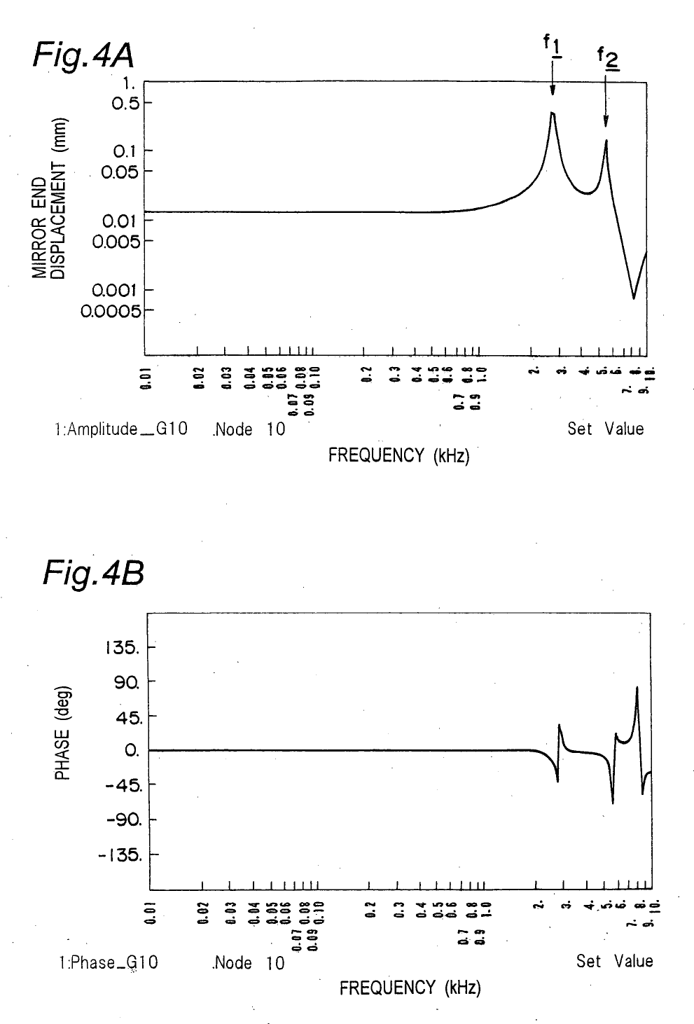

FIGS. 4A and 4B show graphs representing an example of frequency response characteristic of the optical switch of the first embodiment of the present invention. FIGS. 4A and 4B show the frequency characteristic of the optical switch that was analyzed and calculated with regard to the optical actuator having the structure shown in FIG. 1A. A piezoelectric constant d₃₁ of the piezoelectric thin film that was measured in a manufactured piezoelectric thin film (piezoelectric thin film made of PZT) was −100×10⁻¹² m/V, dimensions of the piezoelectric thin film were 2 mm in length, 0.8 mm in width, and 3 μm in thickness, and lengths of the electrode were 0.6 mm in length of the movable end side 4a and 1.2 mm in length of the fixed end side 4b. Aluminum thin plates that had a thickness of 6 μm were used as the elastic members 5, and the torsion springs 6 and the strain absorbers 10 that had a thickness of 6 μm and a width of 50 μm formed a structure in which those and the elastic members 5 were continuous. A silicon substrate was used as the substrate 7, the mirror device 2 that was a part of the substrate 7 left with etching process had a size of 0.5 mm square and a thickness of 0.2 mm, and dimensions of the whole substrate were 6 mm in length, 3 mm in width, and 0.2 mm in thickness.

The rigidity of the electrodes, which was sufficiently smaller than that of other members, was excluded from a computation model in the analytical calculation, and the calculation with finite element method was carried out and proved that the mirror device 1 could be inclined through ±2.9 degrees about the rotation axis by the application of voltage of ±15 V. In the actuator of the embodiment, a piezoelectric thin film having a thickness of several micrometers and manufactured as the piezoelectric member is used, thus a strength of electric field produced in the piezoelectric member can be made large in spite of low applied voltage, and the displacement can efficiently be generated with such low voltage.

This simulation calculation has proved that the mirror device 1 can be inclined most efficiently when a ration of a length La of the electrode 4a on the movable end side to a length Lb of the electrode 4b on the fixed end side is on the order of 1:2 as in the example of calculation described above. At least, the length Lb of the electrode 4b on the fixed end side had better exceed the length La of the electrode on the movable end side 4a. Besides, the calculated angle of the mirror device 1 was far smaller in a structure without the strain absorbers 10, and it was thereby confirmed that such strain absorbers 10 had a great effect of efficiently inclining the mirror device 1.

In an upper graph in FIGS. 4, an abscissa axis represents actuation frequency, and an ordinate axis represents displacement at an end of the mirror device that results from the inclination of the mirror device about the rotation axis. In a lower graph, an abscissa axis represents actuation frequency, and an ordinate axis represents phase of the displacement of the mirror with respect to the actuation frequency. The frequency lower than a main resonant frequency of 2.7 kHz resulted in the response without phase shift, and it was thereby proven that this optical switch was actuated at high speed with switching time not more than 1 msec.

Hereinbelow, a method of manufacturing the optical switch of the first embodiment will be described.

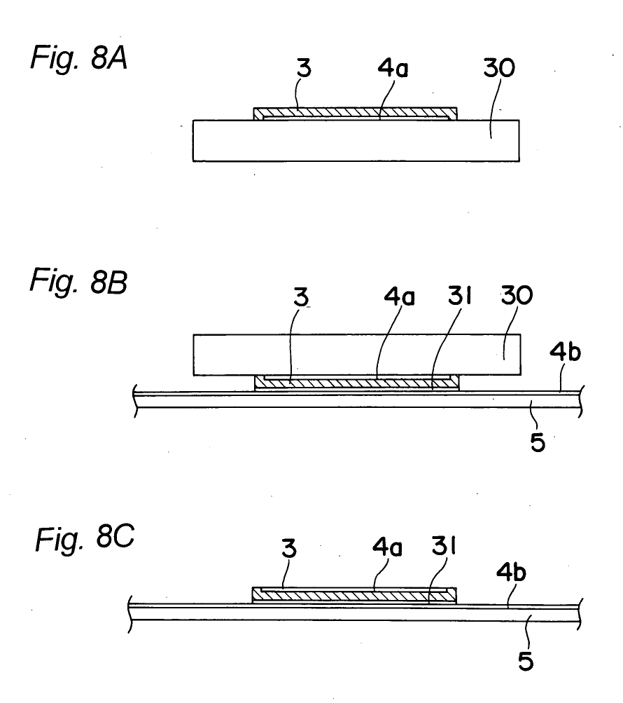

In general, two methods can be employed as the method of manufacturing the optical switch of the first embodiment. The first method is a manufacturing method in which a piezoelectric thin film formed on a substrate is transferred onto another substrate. FIGS. 8A through 8C show sectional views for illustrating steps in this manufacturing process. An electrode 4a is deposited and patterned on a substrate 30 in FIG. 8A, and a piezoelectric thin film 3 is thereafter deposited and patterned similarly on the electrode 4a on the substrate 30. Provided that a film of substrate material advantageous for material property such as piezoelectric constant of the piezoelectric thin film, e.g., PZT (lead zirconate titanate) is manufactured by sputtered deposition in the manufacturing method, the PZT film having excellent piezoelectric property can be obtained with use of an MgO substrate for epitaxial growth of PZT and use of Pt as an under layer (ground layer). In this method, the Pt under layer forms the electrode 4a by itself. The piezoelectric thin film is transferred onto a thin plate, e.g., of stainless as the elastic member 5 with interposition of an adhesive transfer layer 31 (FIG. 8B), the film manufacturing substrate is subsequently removed, and thus the optical switch with the above configuration is formed (FIG. 8C).

The second method is a manufacturing method in which a piezoelectric thin film is directly manufactured on a substrate. Though selection of material of an under layer for the piezoelectric thin film in this method is restrained for obtainment of satisfactory piezoelectric property of the piezoelectric thin film, the manufacturing method is all the simpler because the method does not require transfer process. In the sectional view of the first embodiment of FIG. 2A, for example, the piezoelectric thin film 3 is configured on the elastic member 5 with interposition of the electrode 4c, and it is generally difficult to form the piezoelectric thin film having excellent property on aluminum used in the calculation analysis, as the elastic member. In the direct film manufacturing method, for example, an under buffer layer may be formed on a Si substrate, the electrode and the piezoelectric thin film layer may thereafter be produced, the elastic member layer may thereafter be formed thereon, and the Si substrate under the piezoelectric element may be removed. It goes without saying that a sectional configuration of this optical switch is not necessarily the same as the configuration shown in FIG. 2. As a method of manufacturing a piezoelectric thin film, a sol-gel method may be employed rather than the sputter technique.

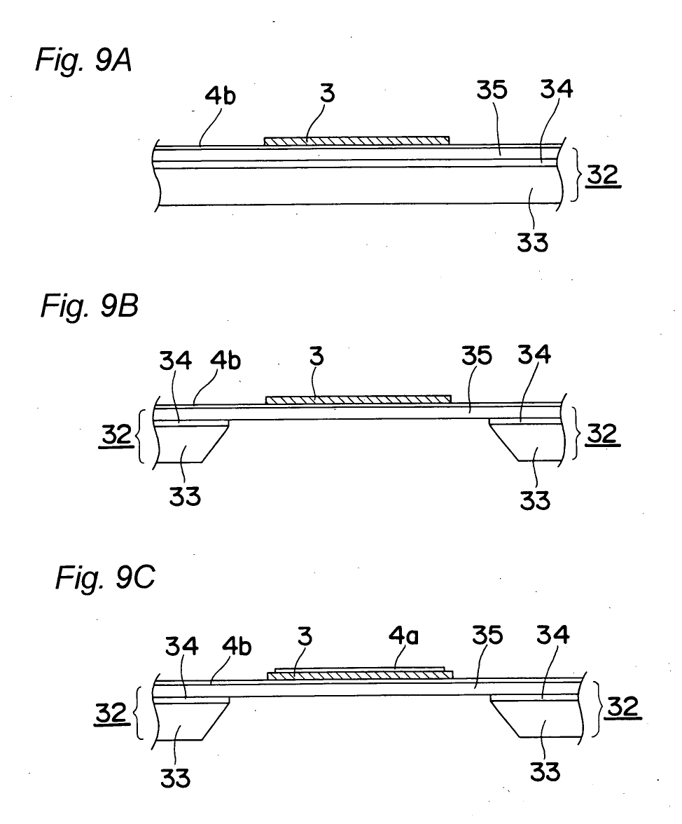

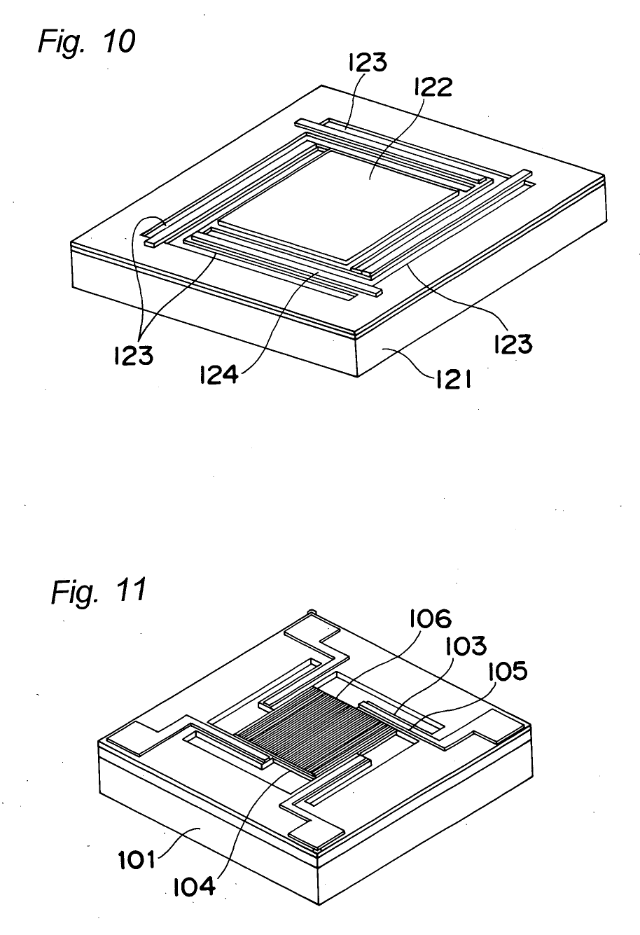

In the method in which the piezoelectric thin film is directly manufactured on Si, it is advantageous to use a Silicon-on-Insulator (SOI) substrate because a silicon thin film constituting the SOI substrate can be left as the elastic member. FIGS. 9A through 9C show explanatory drawings for manufacturing processes using the Silicon-on-Insulator (SOI) substrate. In FIG. 9A, the Silicon-on-Insulator substrate 32 is composed of a silicon thin film 35 formed on an insulator (silicon oxide film) 34 as an under layer on silicon 33. With use of the SOI substrate 32 as the substrate, Pt as the electrode 4b is deposited on the substrate, and PZT is thereafter deposited and patterned on the electrode as an under layer so as to be made into the piezoelectric thin film 3. Subsequently, the silicon 33 and the silicon oxide film 34 as the insulator are removed by etching as shown in FIG. 9B and, finally, the electrode 4a is deposited and patterned as shown in FIG. 9C, so that the piezoelectric element is formed.

In this process, the silicon thin film layer 35 having a uniform thickness can be left with use of etching selectivity between the silicon thin film 35 and the silicon oxide film 34 that is the under layer for the silicon thin film, and thus the uniform elastic member layer 35 having a low flexural rigidity can be formed that is desirable for increase in efficiency of flexure deformation of the piezoelectric element.

Though the example in which only the silicon thin film constituting the SOI substrate is left as the elastic member has been described, both the silicon thin film and the silicon oxide film may be left in an alternative manner. In this case, the piezoelectric element having such a configuration can be formed by time control in dry etching. In addition, internal stress remaining in those thin films can be controlled by change in process conditions such as dose gas atmosphere condition in film manufacturing, and a form accuracy of the piezoelectric element can be ensured by balancing with internal stress in the piezoelectric thin film.

(Second Embodiment)

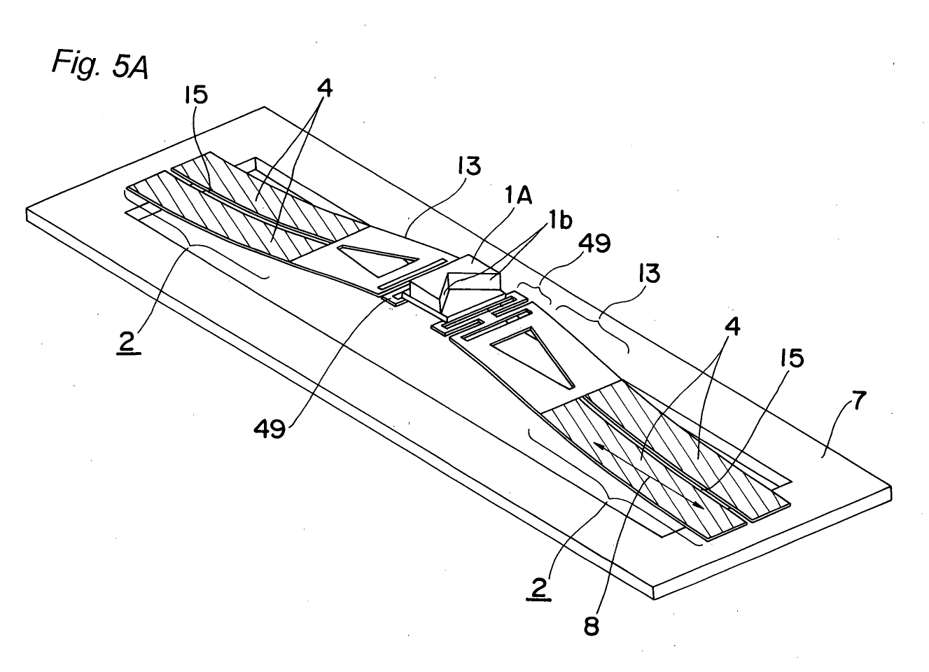

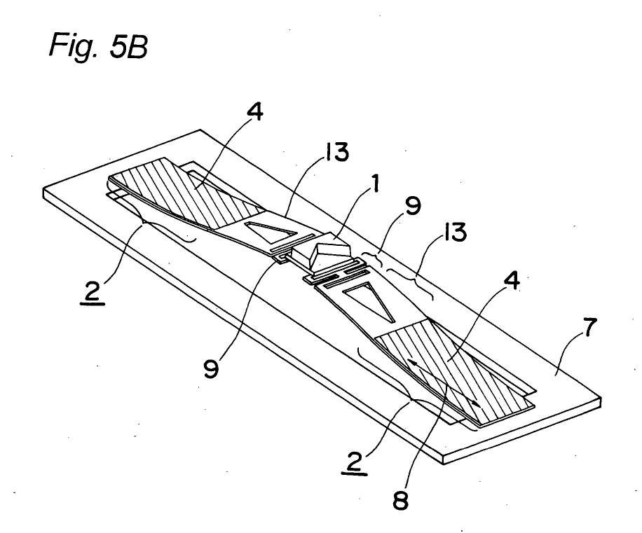

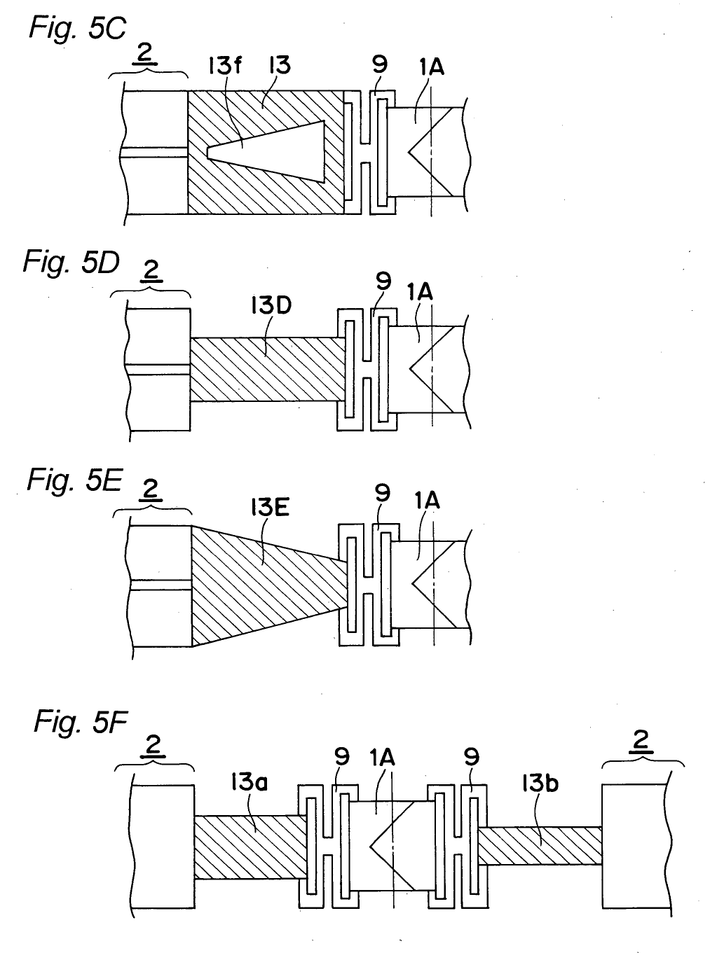

FIG. 5A shows a perspective view of an optical switch of a second embodiment of the present invention. In the second embodiment, mirror surfaces 1b are provided so as to extend in a direction of a normal in FIG. 5A to a substrate surface that is a constituent surface of a piezoelectric thin film, and a mirror device 1A is actuated in the direction of the normal to the substrate surface. Most of components thereof are similar to those in FIG. 1A which have been described as details of the first embodiment, and the common components are therefore designated by the same reference numerals. The piezoelectric thin film 3, electrodes 4, and an elastic member 5 that constitute a piezoelectric element 2 are configured in conformance with the first embodiment and are therefore omitted in the drawing. Though the electrodes 4 composed of two upper electrodes 4a and 4b in a manner similar to the first embodiment are shown as one electrode for simplification in the drawing, the electrodes are configured as shown in FIG. 1A in practice. The electrodes 4, however, may be configured only on a section that flexes with the same curvature, for simplification. In such a simplified configuration, displacement of the mirror device 1A that is actuated is generally decreased, and a low-flexural-rigidity part 13 for compensation for the decrease is configured, instead of the configuration with the strain absorbers 10, in a section that flexes with a reverse curvature with respect to the flexure curvature of the piezoelectric element 2. In the low-flexural-rigidity part 13, specifically, the elastic member tapers from fixed end side which is the electrode side to movable end side on which the mirror device 1A is mounted, so that its area is gradually decreased and flexure with the reverse curvature is efficiently produced. As a result, simplification of the electrode configuration and large displacement efficiency can compatibly be achieved. Grooves 15 are provided at the center of the piezoelectric elements 2 along a longitudinal direction 8 thereof, for purpose of relieving flexure deformation of the piezoelectric elements 2 in a direction of width thereof and for purpose of increasing efficiency of flexure deformation in the longitudinal direction 8.

FIG. 5B shows a simple configuration in which the grooves 15 are not provided and in which the piezoelectric element 2 is not partitioned into two parts in the structure shown in FIG. 5A. In the optical switch of FIG. 5B, displacement is decreased in comparison with that of FIG. 5A by influence of flexure of the piezoelectric elements 2 in the width direction orthogonal to the longitudinal direction 8, while rigidity of the piezoelectric elements 2 is increased, so that a structure with a high resonance frequency and excellence in rapid response can be provided.

FIGS. 5C through 5F are partially plan views showing various modifications different in shape of the low-flexural-rigidity part 13. FIG. 5C shows a configuration, with the same shape as the low-flexural-rigidity part 13 shown in FIG. 5A, in which a generally triangular through hole 13f tapering from the mirror device side to the electrode side is formed at a center of a strip having a width generally the same as the piezoelectric element 2 so that the area of the low-flexural-rigidity part 13 gradually decreases. Contrarily, in FIG. 5D, a low-flexural-rigidity part 13D is shaped like a center beam (doubly-supported beam) having a uniform width far smaller than the width of the piezoelectric element 2 and is arranged along the longitudinal direction 8 at a center with respect to the width direction between the piezoelectric element 2 and a strain absorber 49. In the configuration of FIG. 5D, turning rigidity about the longitudinal direction 8 is decreased, while space in which the strain absorber 49 is to be provided is enlarged, so that rigidity of a part where the low-flexural-rigidity part 13D is positioned can easily be decreased. FIG. 5E shows another example of configuration of a low-flexural-rigidity part 13E, which is tapered so as to have widths decreasing with distance from the piezoelectric element. Such a tapered beam is preferable in terms of material strength because of having an effect of uniforming stress and strain in the beam with respect to the longitudinal direction 8 thereof. FIG. 5F shows an example of configuration in which a pair of low-flexural-rigidity parts 13a and 13b positioned on both sides of the mirror device 1A are made different in rigidity in FIG. 5D. Specifically, a width of the low-flexural-rigidity part 13a is a little smaller than a width of the piezoelectric element 2, and a width of the low-flexural-rigidity part 13b is far smaller than the width of the piezoelectric element 2 and is smaller than the width of the low-flexural-rigidity part 13a. With such unbalanced flexural rigidity, not only can the mirror device 1A be moved vertically but the mirror device 1 can be turned about an axis orthogonal to the longitudinal direction 8. With use of this function, for example, return light reflected from the mirror device 1A can be dropped out of a transmission path.

Hereinbelow will be described a result of a performance calculation with a finite element method for the optical switch having the configuration of the second embodiment. A piezoelectric constant d₃₁ of the piezoelectric thin film that was measured in a manufactured piezoelectric thin film (piezoelectric thin film made of PZT) was −100×10⁻¹² m/V, dimensions of the piezoelectric thin film were 3.2 mm in length, 1.4 mm in overall width, 0.1 mm in width of the groove, and 3 μm in thickness, and a length of the electrode was 3.2 mm. Silicon and a silicon oxide film that had thicknesses of 20 μm and 10 μm, respectively, were used as the elastic member 5, and the strain absorber 10 and the low-flexural-rigidity part 13 were configured in the same manner. A mass of the mirror device 1A was 200 μg. As a consequence, it was found that application of a voltage of 30 V to the electrodes 4 resulted in the displacement of the mirror device 1A by 90.6 μm.

In accordance with a vibration-mode analysis, it was found that a main resonant frequency of the switch was 1.14 kHz and that the switch made rapid response on the order of 1 msec in switching speed.

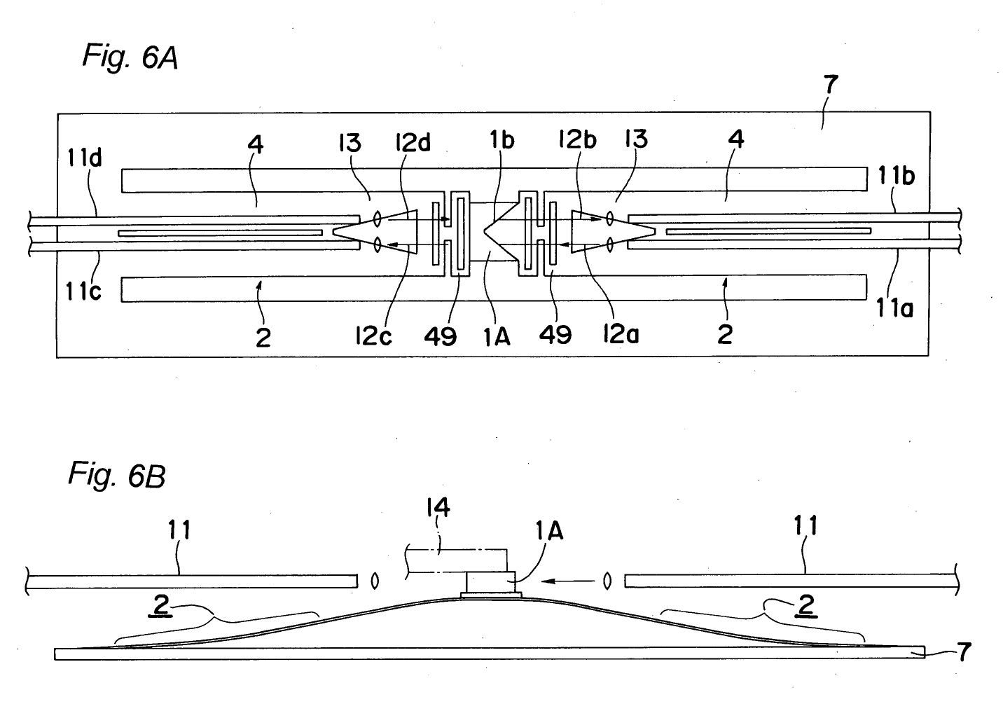

FIGS. 6A and 6B are a plan view and a side view in which the optical switch is shown with transmission lines. When the mirror device 1A is in a position not actuated upward, an input light beam 12a having outgone from a transmission line 11a is made into a light beam 12c outgoing toward a transmission line 11c. When the mirror device 1A is in an upper position of FIG. 6B after being actuated by the piezoelectric elements 2, the input light beam 12a from the transmission line 11a is reflected by the mirror device 1A having the reflection surfaces 1b configured in shape of a letter “V” with an angle of 90 degrees and is made into a light beam outgoing toward a transmission line 11b.

A posture of the mirror device 1A is preferably held with high accuracy by a holding device 14 for the mirror device 1A that is provided as shown by imaginary lines with reference numeral 14 in FIG. 6B. In the mirror turning type described above, the outgoing light is monitored, detection signal obtained from the monitoring is fed back to actuation voltage for the optical switch, and thus the posture of the mirror can be held. In the actuation of the mirror device 1A in the direction of the normal to the substrate surface in FIG. 6B in this embodiment, a reference surface for holding is provided on an upper surface or a lower surface (a mirror device-holding device for the lower surface is omitted in the drawing) of the mirror device 1A, the upper surface of the mirror device 1A is held in the upper position by the mirror device-holding device 14, and therefore the mirror device 1A can easily be held with high accuracy in a position and a posture that have been designed in advance.

As a characteristic of the piezoelectric actuation, the generated force has a property of decreasing with the displacement. Therefore, the mirror device-holding device 14 is preferably a device that holds the mirror device 1A by electrostatic actuation independent of the actuation of the piezoelectric thin film or that mechanically holds the mirror device 1A and, when the mirror device 1A is held, the application of voltage to the piezoelectric thin film is preferably canceled by a control means (e.g., a control means that is provided as the switch 91 of FIG. 1A and that functions to open and close a voltage application circuit for the piezoelectric thin film on basis of information or signal from other devices or the like). In particular, the electrostatic actuation is desirable because such actuation can utilize an electrostatic attractive force between the electrodes across the thin insulating layer, which force increases with decrease in a distance between the electrodes, and because a required current is extremely small so as to result in low electric power.

Though the mirror device having the reflection surfaces 1b configured in shape of the letter “V” has been described as the mirror device 1A, the optical paths may be switched by the mirror device 1A where incident light is simply reflected (e.g., the mirror device 1 as shown in FIG. 1A) or is passed through.

(Third Embodiment)

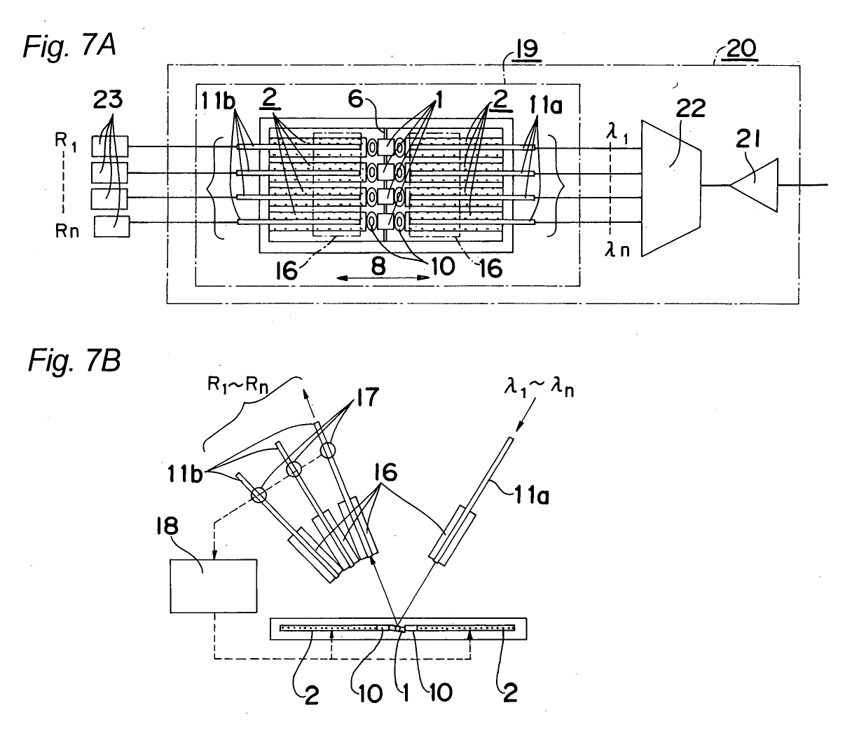

FIGS. 7A and 7B show a plan view and a side view of an information transmission device of a third embodiment of the present invention. In the third embodiment, actuators are composed of a plurality of rows of piezoelectric elements 2 arranged in parallel with a longitudinal direction 8 thereof, and a plurality of optical transmission paths 11 are arranged in correspondence to the plurality of rows of piezoelectric elements 2. With such a configuration, a large number of the optical transmission paths 11 can be arranged in a high density, and an optical switch including the large number of the optical transmission paths can be configured compactly in a small size.

For optical fibers that are used as optical transmission paths, particularly, a large number of fibers are conventionally bundled for use, and the respective fibers are arranged in parallel in a common type of connector that is at terminals of the fibers. In FIG. 7A, the large number of optical transmission paths 11 (specifically, transmission lines 11a, 11b) are arranged in parallel, and terminals thereof are connected to optical connectors 16. Input light beams 12a from the transmission lines 11a are reflected by mirror devices 1 in accordance with angles of inclination of the mirror devices 1 and are made into outgoing light beams 12b directed to the transmission lines 11b. In the optical switch that in which the mirror device 1 is actuated to be inclined, it is difficult to hold the mirror device 1 by a mirror device-holding device. Therefore, a quantity of the outgoing light detected by an output light monitor 17 is inputted into an actuation controller 18, a piezoelectric element 2 is actuated under feedback control based on the detection signal, and thus stable transmission and switch of information can be performed.

As shown by alternate long and short dash lines in FIG. 7A, the information transmission device of the third embodiment of the present invention may be an optical switch device 19 including the actuation controller 18 for the piezoelectric element 1 or may be an information transmission device 20 including functional components peripheral to the device 19. An input to the optical transmission paths resulting from wavelength multiplexing in optical networks is inputted into an optical amplifier 22 and the signals with the multiplexed wavelength are demodulated by the branching filter 22 into individual signals having wavelengths λ₁ through λₙ. The optical transmission paths are introduced into the optical transmission paths 11a of the optical switch device 19 that is an information transmission sub-device. Outputs from the optical transmission paths 11b resulting from switching by the optical switch device 19 are sent to receivers R₁ through Rₙ, and information is thus transmitted to each terminal.

In accordance with the optical switch of the above embodiment of the present invention, the longitudinal directions 8 of the actuating elements thereof are arranged in correspondence to the rows of fibers, and thus a group of optical switches can be configured in a high density. Design of a positioning function of the optical fiber connector with a submicron accuracy is combined with an excellent accuracy of arrangement of a group of a large number of optical switches manufactured with the thin-film Si process of the embodiment of the present invention, and thus the optical switch with a high accuracy and a simple configuration can be provided. In accordance with the embodiment of the present invention, a subminiature optical switch of optical fiber connector embedded type can be obtained by integration of the optical connectors described above, so that an extremely remarkable effect can be provided. In accordance with the present invention by which a reflectance on a reflection interface can accurately be controlled, an insertion loss on the order of −60 dB can be achieved, in other words, a ratio of loss of the outgoing light to the incident light can be decreased to one ten-thousandth in contrast to conventional insertion losses on the order of tens of decibels.

In accordance with the present invention, as described above, a conspicuous effect is achieved in that there are obtained the optical switch which enables high-speed high-accuracy light switching by actuation with low voltage and low electric power in correspondence to expansion of optical communication networks with increase in speed and capacity, which is compact as a device, and which has a specific configuration at practical level including easiness of manufacture; the method of manufacturing the same; and the information transmission device using the same.

By properly combining the arbitrary embodiments of the aforementioned various embodiments, the effects possessed by the embodiments can be produced.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

1-18. (canceled)

19. An optical switch comprising a mirror device for reflecting light from an optical transmission path on incident side and actuators for actuating the mirror device,
the mirror device adapted for switching an optical path of the light incident from the optical transmission path on incident side into an optical transmission path on outgoing side by the actuation performed by the actuator,
the actuators configured by piezoelectric elements comprising piezoelectric thin films, electrodes for applying voltage for actuating the piezoelectric thin films, and elastic members having the piezoelectric thin films and the electrodes, the optical switch, wherein longitudinal directions of the piezoelectric elements confronting across the mirror device are parallel and wherein the mirror device is actuated by flexure deformation of the piezoelectric thin films which is caused by application of voltage to the electrodes.

20. An optical switch as claimed in claim 19, wherein a mirror surface is provided on the mirror device in a plane that is parallel to the piezoelectric thin films and wherein the mirror device is inclined by the actuators relative to the plane that is parallel to the piezoelectric thin films.

21. An optical switch as claimed in claim 20, wherein the actuators comprise a plurality of piezoelectric elements of which the longitudinal directions are arranged in parallel, wherein the mirror device is held by torsion springs that are arranged so as to be orthogonal to the longitudinal directions, and wherein the mirror is thus inclined in a rotation direction such that the torsion springs serve as a rotation axis.

22. An optical switch as claimed in claim 20, wherein the actuators comprise at least a plurality of piezoelectric elements of which both ends are supported as fixed ends and of which the longitudinal directions are arranged in parallel and wherein strain absorbers extending along the longitudinal directions are provided in part of the piezoelectric elements with respect to the longitudinal directions.

23. An optical switch as claimed in claim 19, wherein the actuators are composed of a plurality of piezoelectric elements, wherein each of the piezoelectric elements is partitioned into a plurality of electrodes, and wherein application of different voltages to the electrodes causes the piezoelectric thin films to undergo flexure deformation with different curvatures.

24. An optical switch as claimed in claim 19, wherein the elastic members constituting the piezoelectric elements at least include silicon thin films or silicon oxide films that have constituted a Silicon-on-Insulator substrate.

25. An optical switch as claimed in claim 19, wherein mirror surfaces are provided on the mirror device so as to extend in a direction of a normal to the piezoelectric thin films and wherein the actuators actuate the mirror device in the direction of the normal to the piezoelectric thin films.

26. An optical switch as claimed in claim 25, wherein the actuators comprise at least a plurality of piezoelectric elements of which both ends are supported as fixed ends and of which the longitudinal directions are arranged in parallel and wherein strain absorbers extending along the longitudinal directions are configured in part of the piezoelectric elements with respect to the longitudinal directions.

27. An optical switch as claimed in claim 20, wherein the actuators comprise at least a plurality of piezoelectric elements of which both ends are supported as fixed ends and of which the longitudinal directions are arranged in parallel and wherein low-flexural-rigidity parts that flex with a reverse curvature with respect to a flexure curvature of the piezoelectric elements are configured.

28. An optical switch as claimed in claim 20, wherein the actuators comprise a mirror device holding device for holding the mirror device in a specified position after inclinatory or translational movement of the mirror device.

29. An optical switch as claimed in claim 20, wherein the mirror device holding device is a device that holds the mirror device by electrostatic actuation independent of the actuation of the piezoelectric thin films or mechanically and wherein the application of the voltage to the piezoelectric thin films is canceled when the mirror device is held.

30. A method of manufacturing an optical switch comprising a mirror device for reflecting light from an optical transmission path on incident side and actuators for actuating the mirror device, the mirror device adapted for switching an optical path of the light incident from the optical transmission path on incident side into an optical transmission path on outgoing side by the actuation performed by the actuator,
the method comprising manufacturing a piezoelectric element of the actuators by transferring a piezoelectric thin film formed on a substrate onto another substrate.

31. A method of manufacturing an optical switch comprising a mirror device for reflecting light from an optical transmission path on incident side and actuators for actuating the mirror device, the mirror device adapted for switching an optical path of the light incident from the optical transmission path on incident side into an optical transmission path on outgoing side by the actuation performed by the actuators,
the method comprising manufacturing a piezoelectric element of the actuators by directly producing a piezoelectric thin film on a substrate.

32. A method of manufacturing an optical switch as claimed in claim 31, wherein the substrate on which the piezoelectric thin film is produced is a Silicon-on-Insulator substrate.

33. An information transmission device using an optical switch comprising a mirror device for reflecting light from an optical transmission path on incident side and actuators for actuating the mirror device, the mirror device adapted for switching an optical path of the light incident from the optical transmission path on incident side into an optical transmission path on outgoing side by the actuation performed by the actuator,
the actuators configured by piezoelectric elements comprising piezoelectric thin films, electrodes for applying voltage for actuating the piezoelectric thin films, and elastic members having the piezoelectric thin films and the electrodes, wherein longitudinal directions of the piezoelectric elements confronting across the mirror device are parallel, and wherein the mirror device is actuated by flexure deformation of the piezoelectric thin films which is caused by application of voltage to the electrodes.

34. An information transmission device as claimed in claim 33, wherein a mirror surface is provided on the mirror device in a plane that is parallel to the piezoelectric thin films, wherein the mirror device is inclined by the actuators relative to the plane parallel to the piezoelectric thin films, and wherein a plurality of the optical transmission paths arranged in a plane generally normal to the thin films are thus switched by control of an angle of reflection of the mirror surface.

35. An information transmission device as claimed in claim 33, wherein mirror surfaces are provided on the mirror device so as to extend in a direction of a normal to the piezoelectric thin films and wherein by actuating by the actuators the mirror device in the direction of the normal to the piezoelectric thin films, the mirror device is inserted into a plurality of the optical transmission paths arranged in a plane in parallel with the thin films, and switch the transmission paths.

36. An information transmission device as claimed in claim 34, wherein the actuators comprise a plurality of rows of piezoelectric elements having longitudinal directions arranged in parallel and wherein the plurality of optical transmission paths are arranged in correspondence to the plurality of rows of piezoelectric elements.

37. An optical switch as claimed in claim 25, wherein the actuators comprise at least a plurality of piezoelectric elements of which both ends are supported as fixed ends and of which the longitudinal directions are arranged in parallel and wherein low-flexural-rigidity parts that flex with a reverse curvature with respect to a flexure curvature of the piezoelectric elements are configured.

38. An optical switch as claimed in claim 25, wherein the actuators comprise a mirror device holding device for holding the mirror device in a specified position after inclinatory or translational movement of the mirror device.

39. An optical switch as claimed in claim 25, wherein the mirror device holding device is a device that holds the mirror device by electrostatic actuation independent of the actuation of the piezoelectric thin films or mechanically and wherein the application of the voltage to the piezoelectric thin films is canceled when the mirror device is held.

40. An information transmission device as claimed in claim 35, wherein the actuators comprise a plurality of rows of piezoelectric elements having longitudinal directions arranged in parallel and wherein the plurality of optical transmission paths are arranged in correspondence to the plurality of rows of piezoelectric elements.
